(19) United States
(12) Patent Application Publication
(10) Pub. No.: US 2007/0222765 A1
(43) Pub. Date: Sep. 27, 2007

(54) Slider input lid on touchscreen

(75) Inventor: Tuomo Nyyssonen, Porvoontie (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/388,224

(22) Filed: Mar. 22, 2006

(51) Int. Cl. G06F 3/041

(52) U.S. Cl. 345/173

(57) ABSTRACT

A device features a touch sensitive area, such as a touchscreen or touchpad, responsive to a first set of user interface inputs from a user; a lid arranged in relation to the touch sensitive area, having a physical guiding form for enabling the user to provide a special set of user interface inputs to the touch sensitive area that are different than the first set; and a switch for changing the functionality of the touch sensitive area to respond to the special set of user interface inputs based on the position of the lid in relation to the touch sensitive area. The physical guiding form enables the user to slide their finger on the surface of the lid for providing the special set of user interface inputs, and may be integrated into the lid or include one or more add-on pieces that are coupled on the lid.

### BACKGROUND OF THE INVENTION

1. Technical Field

The present invention relates to a device having a touch sensitive area (e.g. a touchscreen or touchpad), such as a mobile device or personal computer.

2. Description of Related Art

Touchscreens of mobile device known in the art are not an optimal input method for mobile situations, because they need a stable environment, may need a separate pen for providing user inputs, and are not necessarily technically very robust.

### SUMMARY OF THE INVENTION

The present invention provides a new and unique device featuring a touch sensitive area, such as a touchscreen or touchpad, responsive to a first set of user interface inputs from a user; a lid arranged in relation to the touch sensitive area, having a physical guiding form for enabling the user to provide a special set of user interface inputs to the touch sensitive area that are different than the first set; and a switch for changing the functionality of the touchscreen to respond to the special set of user interface inputs based on the position of the lid in relation to the touch sensitive area.

The physical guiding form enables the user to slide their finger on the surface of the lid for providing the special set of user interface inputs. The physical guiding form may be integrated into the lid or include one or more add-on pieces that are coupled on or to the lid.

The lid can open with a hinge or can slide away to activate the first set of user interface inputs, which may include a traditional set of touch sensitive area user interface inputs. The lid may be interchangeable based on the application the user runs on the device or by the manufacturer. The lid may be a solid piece of plastic or other suitable material.

The special set of user interface inputs may be combined with visual graphics seen through a semi-transparent lid or an opening in a solid lid.

In one embodiment according to the present invention, a capacitive touchscreen can be temporarily turned to a convenient input slider by adding a special lid or cover on it. The lid or cover has the physical guide form on it that guides a user's finger which slides on the surface of the lid for providing the special set of user interface inputs. The lid or cover may be opened with a hinge or can be slid away to activate the traditional full touchscreen user interface inputs. This opening action automatically switches the input mode of the device and the graphics to a full screen interaction mode, including from a “music phone mode” to a “smartphone mode”. In the “music phone mode”, the special set of UI inputs may include voice control, play, pause, forward, etc. In dedicated devices, the lid may also be solid. Also the lid or cover may be dedicated to a software or an application as a possible option.

Options and benefits of the present invention include the following:
The ability to provide suitable forms for dedicated inputs, including passive physical domes, rotating parts, etc.;
The ability to provide single components for bridges;
No active moving parts, only passive forms where the fingers slide easily;
With dedicated software, a dedicated combination of input components may be provided onto a display, which is comparable to custom PC keyboards for video editing, for instance.
Potential applications, such as music, media, editing tools, adjusting, tuning, photo editing etc., including gaming and other innovative interaction methods providing software.
Very slight variants are possible and useful: For example, a ½ millimeter rise or recess on the display does not block display area visually, but already helps to find things by touch.

### BRIEF DESCRIPTION OF THE DRAWING

The drawing includes the following Figures, that are not necessarily drawn to scale:

FIG. 1 shows a basic block diagram of the device according to the present invention.

FIG. 2a shows the main parts of one embodiment of the device having a slider shaped lid according to the present invention.

FIG. 2b(i) shows a user holding the device shown in FIG. 2a.

FIGS. 2b(ii) and 2b(iii) show side view of the device shown in FIG. 2b(i).

FIG. 2b(iv) shows a top view of the device shown in FIG. 2b(i).

FIG. 3a shows another embodiment of the device having a rotator lid according to the present invention.

FIG. 3b shows the main parts of the embodiment of the device shown in FIG. 3a.

FIG. 3c shows the rotator lid construction of the device shown in FIG. 3a.

FIG. 4a shows another embodiment of the device having a rotator lid in the closed position according to the present invention.

FIG. 4b shows the rotator lid in FIG. 4a in the open position according to the present invention.

FIG. 5a shows another embodiment of the device having a semi-transparent lid with a volume control view according to the present invention.

FIG. 5b shows another embodiment of the device having a semi-transparent lid with a music level illustration according to the present invention.

FIG. 5c shows another embodiment of the device having a semi-transparent lid with a dial view according to the present invention.

FIG. 5d shows another embodiment of the device having a semi-transparent lid with a clock view according to the present invention.

FIG. 5e shows another embodiment of the device having a semi-transparent lid and transparent window according to the present invention.

FIG. 6a shows another embodiment of a PC screen lid according to the present invention.

FIG. 6b shows another embodiment of the device having the PC screen lid shown in FIG. 6a arranged thereon as an adjustable bridge.

### BEST MODE FOR CARRYING OUT THE INVENTION

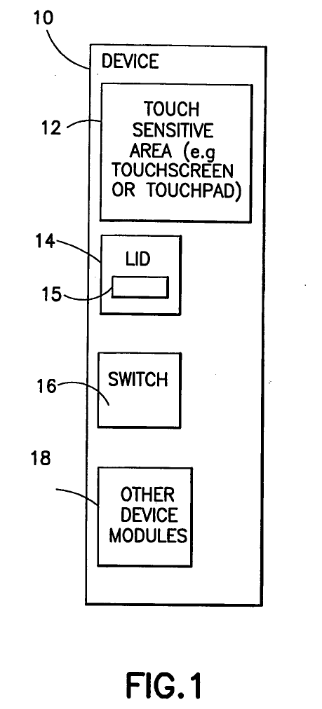

### FIG. 1: The Basic Invention

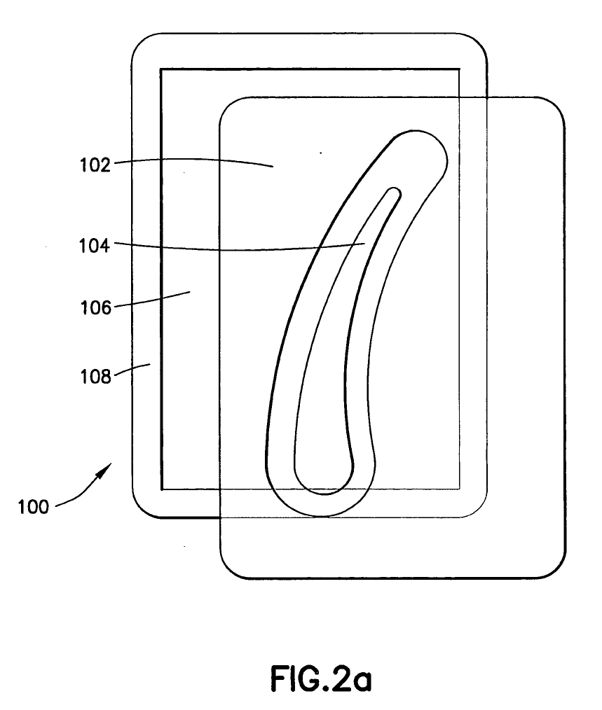

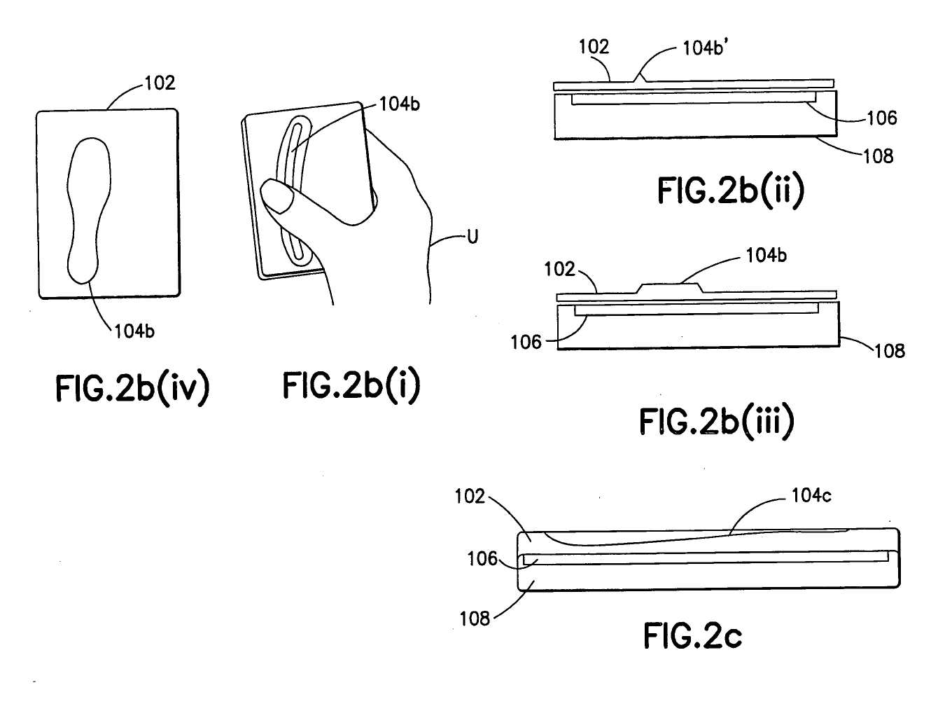

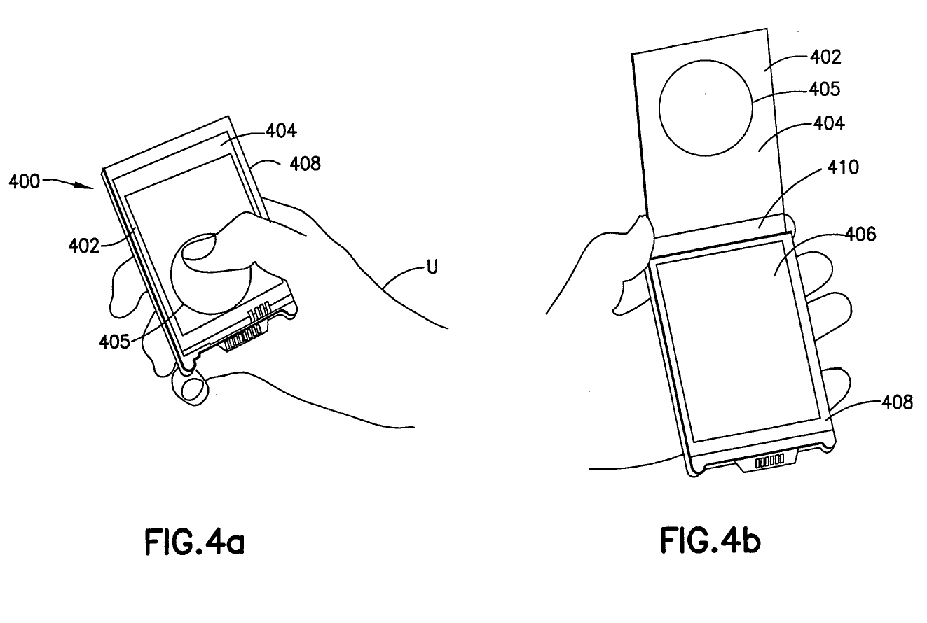

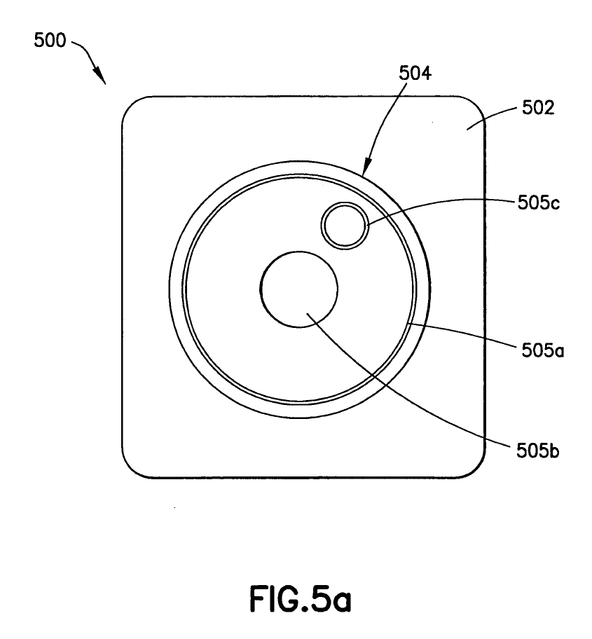

FIG. 1 shows the basic invention of a new and unique device generally indicated as 10, featuring a touch sensitive area, such as touchscreen or touchpad 12, responsive to a first set of user interface inputs from a user U (see FIG. 2b or 4); a lid 14 arranged in relation to the touchscreen or touchpad 12, having a physical guiding form 15 for enabling the user to provide a special set of user interface inputs to the touchscreen or touchpad 12 that are different than the first set; and a switch 16 for changing the functionality of the touchscreen or touchpad 12 to respond to the special set of user interface inputs based on the position of the lid 14 in relation to the touchscreen or touchpad 12.

According to the present invention, the physical guiding form 15 enables the user to slide their finger on the surface of the lid 14 for providing the special set of user interface inputs. The physical guiding form may be may be integrated into the lid 14 or include one or more add-on pieces that are coupled to or on the lid 14.

The lid 14 can open with a hinge or can slide away to activate the first set of user interface inputs, which may include a traditional set touchscreen of user interface inputs. The lid may be interchangeable based on the application the user runs on the device 10. The may be solid, transparent or some combination thereof.

The special set of user interface inputs may also being combined with visual graphics seen through a semi-transparent lid or an opening in a solid lid, consistent with that shown and described herein.

The touch sensitive area may take the form of a capacitive touchscreen or touchpad, which are both known in the art, although the scope of the invention is intended to include other types or kinds of touch sensitive areas, touchscreens or touchpads either now known or later developed in the future.

The switch 16 may include, or form part of, the hinge or slide away member, which are known in the art, although the scope of the invention is intended to include other types or kinds of switches either now known or later developed in the future.

The device 10 may include other device modules 18 such as one or more processor or control modules for processing user interface inputs control and data signals received from and/or provided to the touchscreen, switch control signals received from and/or provided to the switch, as well as other functionality for implementing the present invention shown and described herein. Such processor or control modules may be implemented using hardware, software, or a combination thereof. In a typical software implementation, such a processor or control module may include a microprocessor-based architecture having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation. The other device modules 18 may also include other modules or circuits that are known in the art and do not form part of the present invention, including but not limited to input/output modules or circuits, keyboard modules or circuits, audio modules or circuits, transceiver modules or circuits, etc.

### FIGS. 2a, 2b, 2c

FIGS. 2a, 2b, 2c show one example of a device generally indicated as 100 according to the present invention, where the lid 14 is a slider shaped lid 102 and the physical guide form takes the form of a slider rise/recess 104. As shown, the slider shaped lid 102 is arranged in relation to a touchscreen 106 that forms part of a housing 108 of the device 100.

In FIGS. 2b(i), (ii), (iii) and (iv), the slider rise/recess 104 of FIG. 2a is shown as a slider rise 104b and the physical guide form 15 includes a sharp slider edge 104b′.

In FIG. 2c, the slider rise/recess 104 of FIG. 2a is shown as a slider recess 104c and the physical guide form 15 includes a depression in the slider lid 102.

In either case, the physical guiding form enables the user to slide their finger on the surface of the slider shaped lid 102 for providing the special set of user interface inputs.

In operation, when the slider lid 102 is in the open position, traditional touchscreen user interface (UI) may be in use. In contrast, when the slider lid 102 is in the closed position, the special set of touchscreen UI may be in use. For example, when the device is in a user's pocket, the lid is typically closed, and only limited functions are available, with help of physical capacitive form for simplified “blind use”. The physical slider input form 104 on the top of the capacitive touchscreen 106 enables large movements in interaction by the user.

It is noteworthy that the scope of the invention is not intended to be limited to any particular type, kind, shape or size of the physical guide form on the lid. Embodiments are envisioned using other types, kinds, shapes or sizes of the physical guide forms than those shown and described herein, as well as using more than one physical guide forms on the lid.

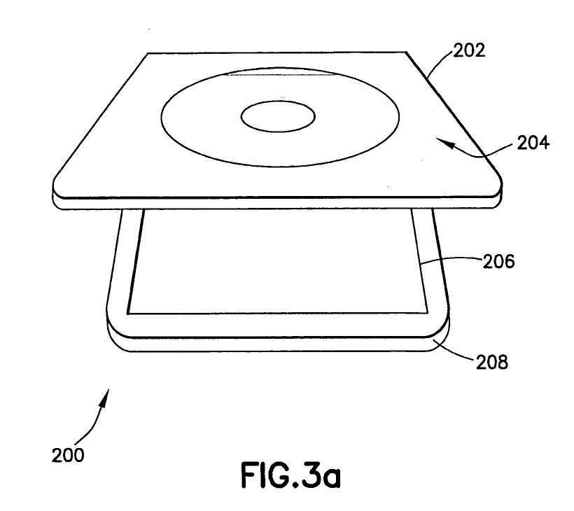

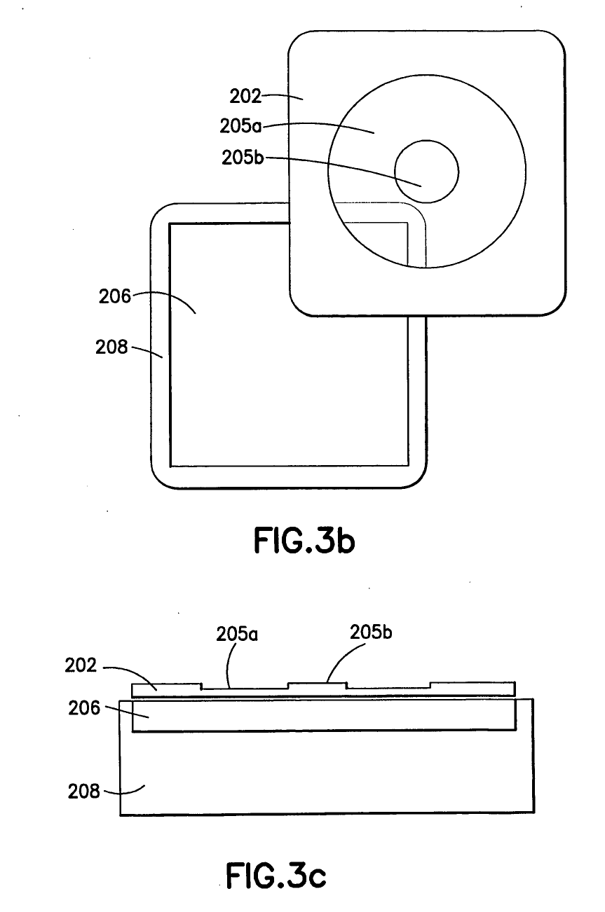

### FIGS. 3a, 3b, 3c

FIGS. 3a, 3b, 3c show another example of a device generally indicated as 200 according to the present invention, where the lid 14 is a rotator lid 202 and the physical guide form takes the form of a semi-transparent masking generally indicated as 204, having a transparent scroll area 205a and a virtual-physical select button 205b. As shown, the rotator lid 202 is arranged in relation to a touchscreen 206 that forms part of a housing 208 of the device 200. The semi-transparent masking 204 is placed on the touchscreen 206 for providing special input and visual effects to the device 200.

When the rotator lid 202 is open as shown in FIG. 3a, the device 202 provides full interaction with traditional touchscreen UI for the user.

When the rotator lid 202 is closed, only the music and media scroller 205a, and the select button 205b in middle of it, are in use for providing the special set of UI inputs in the form of, for example, the special input and visual effects.

In one particular embodiment, the device may be switched between a smartphone mode or a musicphone mode depending on the position of the lid 202. In effect, the rotator lid 202 masks the capacitive touchscreen so that a round area is left interactive. This form is suitable for media-, menu- or music scrolling, volume adjusting, etc. The form and feel of the lid 202 enables using several functions without seeing the device 200 or touchscreen display 206. Moreover, the semi-transparent lid 202 with the fully transparent scroll area 205a enables also many visual effects and creative design with UI elements.

In practice, the switch 14 (FIG. 1) may take the form of a mode switch that can be realised based on a physical switch or capacitive recognition, which are techniques both known in the art. The scope of the invention is not intended to be limited to any particular type or kind of mode switch either now known or later developed in the future.

Further, embodiments are envisioned in which the construction can be combined with vibro-tactual and/or audio feedback in response to UI inputs.

### FIGS. 4a, 4b

FIGS. 4a, 4b show another example of a device generally indicated as 400 according to the present invention, where the lid 14 is a rotator lid 402 and the physical guide form takes the form of a transparent lid generally indicated as 404, having an opening 405. The transparent lid 404 is shown as a plastic plate, although the scope of the invention is not intended to be limited to any particular type or kind of material being used for the lid. For example, embodiments are envisioned using other types or kind of materials either now known or later developed in the future. As shown, the rotator lid 402 is arranged in relation to a touchscreen 406 that forms part of a housing 408 of the device 400. The rotator lid 402 is placed on the touchscreen 406 for providing the special set of UI inputs, consistent with that shown and described herein.

As shown, the device 400 has an adhesive tape 410 as a hinge. Adhesive tapes are known in the art and the scope of the invention is not intended to be limited to any particular type or kind thereof for using as the hinge. For example, embodiments are envisioned using other types or kind of adhesive tapes either now known or later developed in the future.

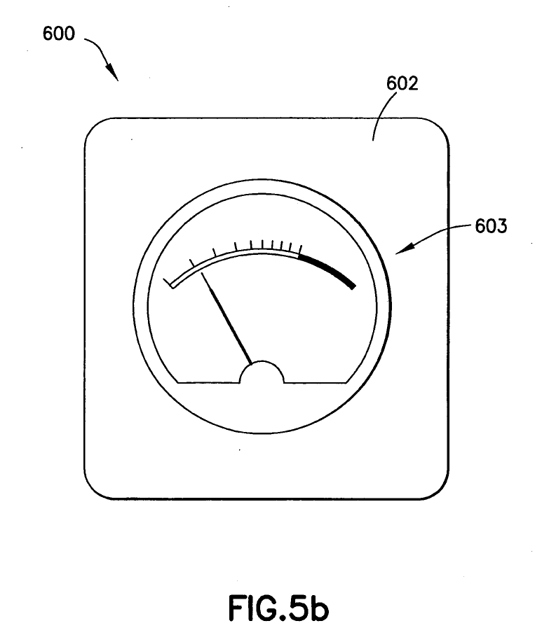

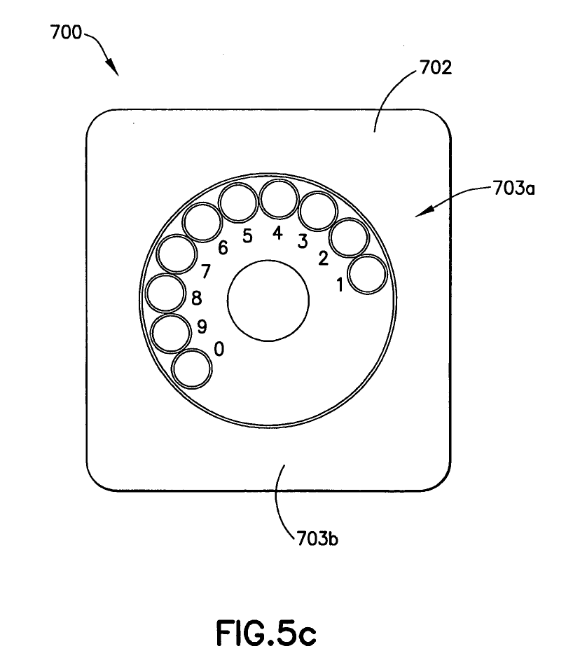

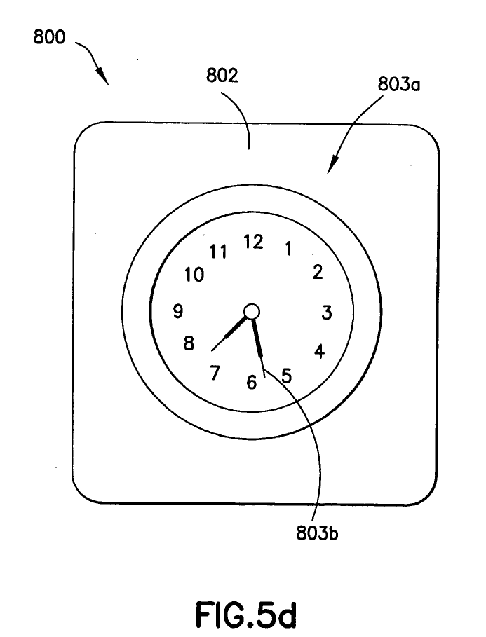

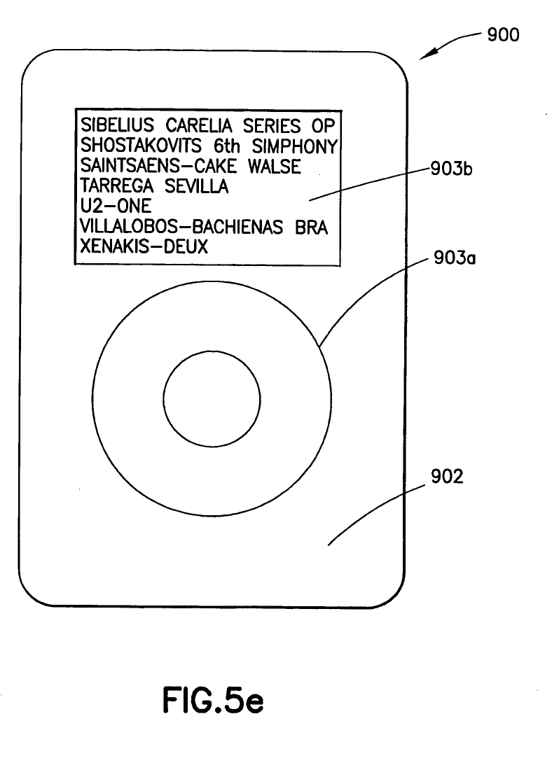

### FIGS. 5a to 5e

FIGS. 5a to 5e show, by way of example, different embodiments having different types of semi-transparent lids with different types of views and different types of visual graphics.

FIG. 5a shows an embodiment of a device generally indicated as 500 having a semi-transparent lid 502 similar to the rotator lid shown in FIGS. 3a, 3b which may be used as a volume control for adjusting the volume of the device 500. In this case, the volume adjusts with an interactive virtual volume knob. The visual knob graphics 505c are placed or displayed on the round touch area 505a, and other information on the semi-transparent area such as 505b. The volume can be easily adjusted with the finger by turning the knob 505c even if the device 500 is in the pocket of the user. Although the embodiment is described in relation to controlling the volume of the device, the scope of the invention is not intended to be limited to the same. For example, embodiments are envisioned for controlling other types or kinds of functionality of the device either now known or later developed in the future, including but not limited to controlling the bass, treble and/or balance of the device.

FIG. 5b shows an embodiment of a device generally indicated as 600 having a semi-transparent lid 602 which may be used as a music level illustration generally indicated as 603 for displaying the music level of the device 600. The visual graphics are seen through the semi-transparent lid 602. Although the embodiment is described in relation to controlling the music level of the device, the scope of the invention is not intended to be limited to the same. For example, embodiments are envisioned for controlling other types or kinds of functionality of the device either now known or later developed in the future, including but not limited to controlling and displaying the graphic equalization of the music of the device.

FIG. 5c shows an embodiment of a device generally indicated as 700 having a semi-transparent lid 702 with a phone dial view generally indicated as 703a which may be used to make phone calls on the device 700. The dialed number 703b may be shown on the inactive cover part of the lid. Although the embodiment is described in relation to make phone calls on the device, the scope of the invention is not intended to be limited to the same. For example, embodiments are envisioned for providing other types or kinds of functionality on the device either now known or later developed in the future, including but not limited to providing calculator functionality, etc.

FIG. 5d shows an embodiment of a device generally indicated as 800 having a semi-transparent lid 802 with a clock view generally indicated as 803a which may be used to provide the time on the device 800. The time and/or alarm can be set by moving the clock hands 803b directly on the interactive area. Although the embodiment is described in relation to show the time on the device, the scope of the invention is not intended to be limited to the same. For example, embodiments are envisioned for displaying other types or kinds of functionality on the device either now known or later developed in the future, including but not limited to displaying the temperature, etc.

FIG. 5e shows an embodiment of a device generally indicated as 900 having a semi-transparent lid 902 with a rotator lid opening 903a for providing “limited” touch interaction and a transparent window 903b for showing data in a small display related, for example, to music playing on the device, such as the name of the song, as well as some other device functionality. Although the embodiment is described in relation to show data related to music playing on the device, the scope of the invention is not intended to be limited to the same. For example, embodiments are envisioned for displaying other types or kinds of information on the device either now known or later developed in the future, including but not limited to displaying stock or weather information being broadcast on the device, etc.

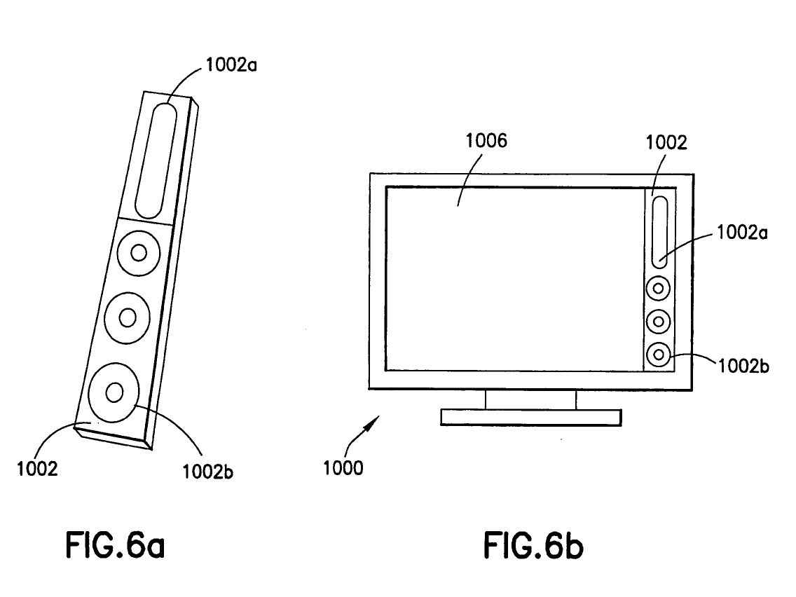

### FIGS. 6a, 6b

FIGS. 6a, 6b shows an embodiment of a device generally indicated as 1000 in the form of a PC having a screen lid 1002 arranged on a touchscreen 1006. The screen lid 1002 has a slide opening (or “bridge”) 1002a and one or more rotator lid openings 1002b for implementing functionality related to the touchscreen, including adjusting the colour balance. The screen lid 1002 can easily be turned onto and off the display using a hinge (not shown).

### The Scope of the Invention

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

1. A device comprising:
a touch sensitive area responsive to a first set of user interface inputs from a user;
a lid arranged in relation to the touch sensitive area, having a physical guiding form for enabling the user to provide a special set of user interface inputs to the touch sensitive area that are different than the first set; and
a switch for changing the functionality of the touch sensitive area to respond to the special set of user interface inputs based on the position of the lid in relation to the touch sensitive area.

2. A device according to claim 1, wherein the physical guiding form enables a user to slide their finger on the surface of the lid for providing the special set of user inputs.

3. A device according to claim 1, wherein the touch sensitive area is a capacitive touchscreen device or a touchpad.

4. A device according to claim 1, wherein the lid can open with a hinge or can slide away to activate a full set of touch sensitive area user interface functionality.

5. A device according to claim 4, wherein the opening of the lid automatically switches the input mode and graphics to full screen interaction mode, including changing the functionality from a “music phone mode” to a “smartphone mode”, and vice versa when the lid is closed.

6. A device according to claim 4, wherein the opening of the lid automatically switches a software program or other application.

7. A device according to claim 4, wherein the lid is a solid piece of plastic or other suitable material.

8. A device according to claim 3, wherein the physical guiding form is integrated into the lid or includes one or more add-on pieces that are coupled on the lid.

9. A device according to claim 1, wherein the lid or the physical guiding form is interchangeable according to applications the user runs on the device.

10. A device according to claim 1, wherein the physical guiding form is a rotator lid or a slider lid for providing music, media or browsing user inputs.

11. A device according to claim 10, wherein the rotator lid includes a piece of transparent material such as plastic with a rotator form.

12. A device according to claim 10, wherein the rotator lid includes a plastic plate with a round hole for guiding a user finger for providing user inputs.

13. A device according to claim 1, wherein the lid has an adhesive tape as a hinge.

14. A device according to claim 1, wherein the device is a personal computer (PC), and the lid is an adjusting bridge add-on for the PC touchscreen.

15. A device according to claim 1, wherein the lid is a masking lid placed on the touch sensitive area for providing special input and visual effects.

16. A device according to claim 15, wherein the masking lid includes a semi-transparent mask, a transparent scroll area, a virtual-physical select button, or some combination thereof.

17. A device according to claim 3, wherein the physical guiding form is a rise or recess in or on the lid.

18. A device according to claim 17, wherein the rise includes a sharp slider edge.

19. A device according to claim 17, wherein the rise includes a flat slider edge.

20. A device according to claim 17, wherein the recess is a curved recess.

21. A device according to claim 14, wherein the adjusting bridge add-on includes one or more slider openings, one or more rotator openings, or some combination thereof.

21. A device according to claim 1, wherein the special set of user inputs includes dedicated inputs, for applications involving video, music, photo, media, using editing tools such as adjusting or tuning.

22. A device according to claim 1, wherein the special set of user inputs are combined with a vibro-tactile and/or audio response.

22. A device according to claim 1, wherein the special set of user interface inputs are combined with visual graphics seen through a semi-transparent lid.

23. A device according to claim 22, wherein the visual graphics include analogue control view, such as a volume view, a dial view, a clock view or a meter view.

24. A device according to claim 22, wherein the visual graphics include a digital control view.

25. A device according to claim 22, wherein the visual graphics include an alphanumeric view containing information related to the graphic user input.

26. A device according to claim 1, wherein the lid is moved to one position for operating the touch sensitive area with the first set of user interface inputs, and moved to another position for operating the touch sensitive area with the special set of user interface inputs.
